(19) United States
(12) Patent Application Publication
(10) Pub. No.: US 2026/0109094 A1
(43) Pub. Date: Apr. 23, 2026

(54) CORE BACK INDUCTIVE HEATING INJECTION MOLDING SYSTEM

(71) Applicant: GM GLOBAL TECHNOLOGY OPERATIONS LLC, Detroit, MI (US)

(72) Inventors: Thomas E. EMERY, Leonard, MI (US); Ramon Andres Cordero, Sterling Heights, MI (US); Jaime S. Hollatz, Clarkston, MI (US)

(21) Appl. No.: 18/918,770

(22) Filed: Oct. 17, 2024

(51) Int. Cl. B29C 45/73

(52) U.S. Cl. CPC B29C 45/7306; B29C 2045/7362

(57) ABSTRACT

A core back injection molding system includes a mold including a mold body having a mold cavity. The mold body includes a first mold half having a first portion of the mold cavity and a second mold half having a second portion of the mold cavity. An induction heating system including an induction heating coil is arranged in the first mold half. A core back controller is operatively connected to the mold and the induction heating system. The core back controller is configured to fill the mold cavity with a molten material including a foaming agent, separate the first mold half from the second mold half a selected amount allowing the foaming agent to expand the molten material, activate the induction heating system to promote flow of the molten material in the mold cavity, and eject a part formed from the molten material from the mold.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the art of component forming systems and, more particularly, to a core back injection molding process including an induction heating system.

Components for systems, such as vehicles, are formed using a wide variety of techniques. The particular technique used often is dictated by material choice. Components formed from metals may be cast, machined, stamped or the like. Components made from plastics may be molded or formed through additive manufacturing techniques. Plastic molding includes a variety of techniques. Plastic may be poured into a mold or may be injection molded to form a part. Injection molding includes standard molding techniques and core back molding techniques. In standard molding techniques the material is melted and injected into a cavity defined between two mold parts to form the part. The two mold parts are then separated, and the part ejected. In core back molding techniques, the two mold parts are separated prior to the material solidifying. The separation of the two mold parts allows that material to expand to a final form before hardening.

Core back injection molding involves injecting melted plastic infused with a foaming agent into a mold cavity. After injection, the two mold parts are separated a selected distance forming a gap. The plastic solidifies and expands into the gap to form the final component shape. The foaming agent forms voids in the plastic. The voids lead to a reduction in component weight without sacrificing component structural integrity.

### SUMMARY

A core back injection molding system, in accordance with the present disclosure, includes a mold including a mold body having a mold cavity. The mold body includes a first mold half having a first portion of the mold cavity and a second mold half having a second portion of the mold cavity. An induction heating system including an induction heating coil is arranged in the first mold half. A core back controller is operatively connected to the mold and the induction heating system. The core back controller is configured to fill the mold cavity with a molten material including a foaming agent, separate the first mold half from the second mold half a selected amount allowing the foaming agent to expand the molten material, activate the induction heating system to promote flow of the molten material in the mold cavity, and eject a part formed from the molten material from the mold.

In further accordance with the present disclosure, a cooling system includes a first cooling channel extending through the first mold half and a second cooling channel extending through the second mold half.

In further accordance with the present disclosure, the core back controller is configured to deactivate the induction heating system allowing the molten material to cool and solidify.

In further accordance with the present disclosure, one of the first mold half and the second mold half includes a seal that extends about the corresponding one of the first portion of the mold cavity and the second portion of the mold cavity.

In further accordance with the present disclosure, a vacuum system is fluidically connected to the mold cavity, wherein the core back controller is configured to activate the vacuum system to draw the molten material into the mold cavity.

In further accordance with the present disclosure, the core back controller includes a parallelism module configured to maintain alignment of the first mold half and the second mold half.

In further accordance with the present disclosure a core back controller includes an injection module, a core back module, and an induction heating control module. The core back controller is configured to activate the injection module to inject a molten material including a foaming agent into a mold having a mold cavity , the mold cavity having a first portion defined in a first mold half and a second portion defined in a second mold half, separate the first mold half from the second mold half a selected amount allowing the foaming agent to expand the molten material through the core back module, control an induction heating system through the induction heating control module to promote flow of the molten material in the mold cavity, and fully separate the first mold half and the second mold half to eject a part formed from the molten material from the mold.

In further accordance with the present disclosure, the core back controller is configured to activate a cooling system to pass a turbulent flow of coolant through the mold reduce mold temperatures after deactivating the induction heating system.

In further accordance with the present disclosure, the core back controller is configured to pass coolant through a first cooling channel arranged in the first mold half and a second cooling channel arranged in the second mold half.

In further accordance with the present disclosure, the core back controller is configured to close the mold creating a seal between the first mold half and the second mold half.

In further accordance with the present disclosure, the core back controller is configured to activate a vacuum system creating a negative pressure in the mold cavity when injecting the molten material.

In further accordance with the present disclosure, the core back controller includes a parallelism module configures to maintain alignment between the first mold half and the second mold half.

A method of forming a component with a core back injection molding process, in accordance with the present disclosure, includes

filling a mold cavity defined between a first mold half and a second mold half of a mold with molten material including a foaming agent, activating an induction heating system embedded in one of the first mold half and the second mold half to heat the mold and the molten material, separating the mold by shifting the first mold half away from the second mold half a selected distance allowing the molten material to expand and solidify to form a component, and ejecting the component from the mold.

In further accordance with the present disclosure, a cooling system is activated to pass a turbulent flow of coolant through the mold to cool the molten material.

In further accordance with the present disclosure, activating the cooling system includes passing a cooling medium through a cooling channel arranged in at least one of the first mold half and the second mold half when filling the mold cavity.

In further accordance with the present disclosure, passing the cooling medium through the cooling channel includes maintaining the turbulent flow of cooling medium through a first cooling channel arranged in the first mold half and a second cooling channel arranged in the second mold half after deactivating the induction heating system.

In further accordance with the present disclosure, a seal arranged about a first portion of the mold cavity formed in the first mold half is engaged with the second mold half to form the mold cavity.

In further accordance with the present disclosure, a negative pressure is created in the mold cavity when filling with the molten material.

In further accordance with the present disclosure, alignment between the first mold half and the second mold half is maintained when separating the mold.

In further accordance with the present disclosure, activating an induction heating system includes activating an induction heating coil arranged in the first mold half.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 depicts a core back injection molding system including a mold having a first mold half and a second mold half, in accordance with the present disclosure;

FIG. 2 a perspective view of the first mold half for the core back induction heating injection molding system of FIG. 1, in accordance with the present disclosure;

FIG. 3 is a plan view of the second mold half for the core back induction heating injection molding system of FIG. 1 , in accordance with the present disclosure; and

FIG. 4 is a block diagram depicting a control system for the core back induction heating injection molding system, in accordance with a non-limiting example;

FIG. 5 is a flow diagram depicting a method of core back injection molding, in accordance with the present disclosure;

FIG. 6A depicts a first mold half against a second mold half forming a mold cavity and a flow of coolant through the mold, in accordance with the present disclosure;

FIG. 6B depicts a molten material infused with a foaming agent injected into the mold cavity of FIG. 6A heated by an induction heating system, in accordance with the present disclosure;

FIG. 6C depicts the first mold half separated from the second mold half allowing the molten material to expand;

FIG. 6D depicts a cooling system maintaining the flow of coolant through the first mold half and the second mold half after deactivating the induction heating system allowing the molten material to solidify forming a component, in accordance with the present disclosure; and

FIG. 6E depicts the component ejected from the second mold half, in accordance with the present disclosure.

In the drawings, reference numbers may be reused to identify similar and/or identical elements.

### DETAILED DESCRIPTION

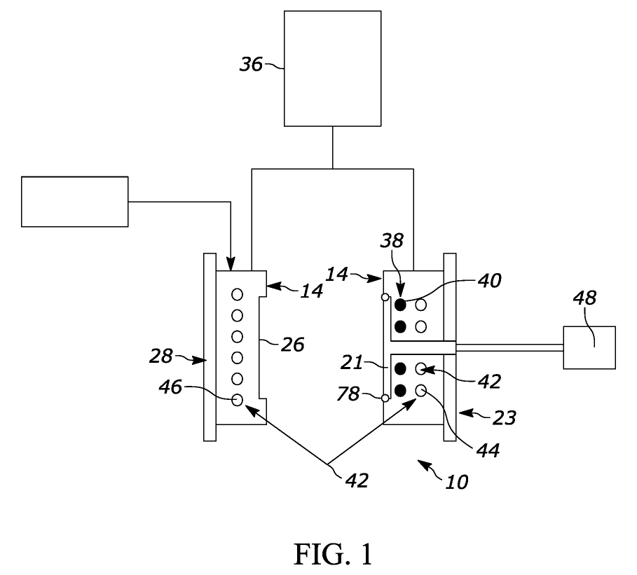

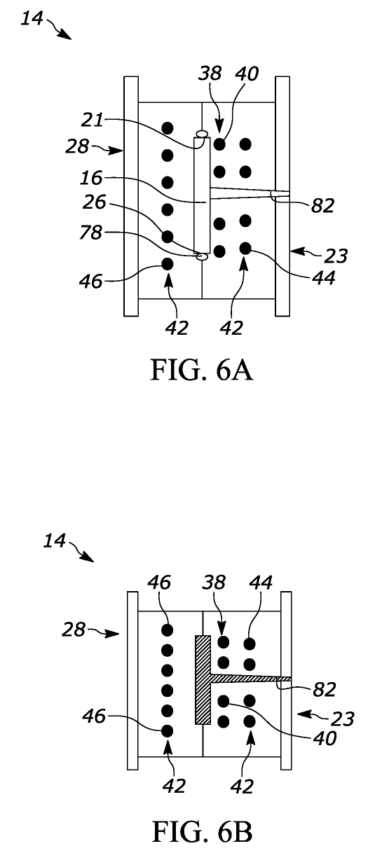

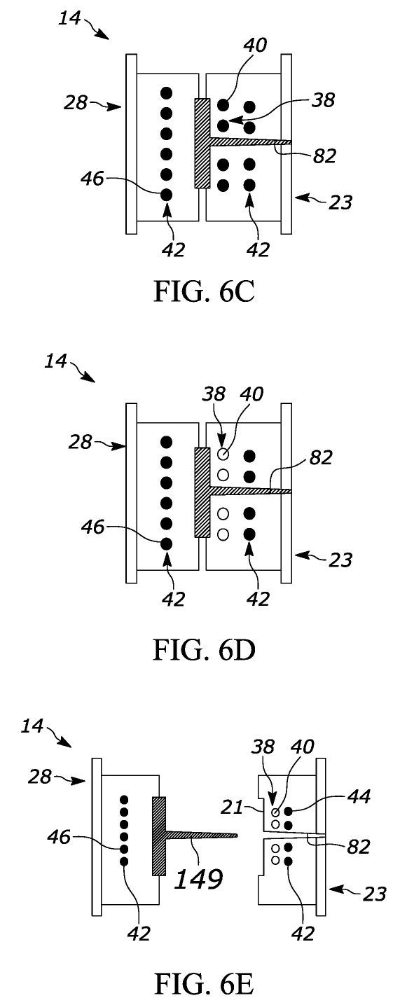

A core back injection molding system, in accordance with the present disclosure, is indicated generally at 10 in FIG. 1. Core back injection molding system 10 includes a mold 14 having a mold cavity 16 (FIG. 6A). Mold cavity 16 includes a first portion 21 defined in a first mold half 23 and a second portion 26 defined in a second mold half 28. First mold half 23 is moved toward and brought together with second mold half 28 to form mold 14 and mold cavity 16. Mold 14 is operatively connected to a core back controller 36 that controls a core back injection molding process in accordance with the present disclosure.

Mold 14 includes an induction heating system 38 including an induction heating coil 40 arranged in first mold half 23. Mold 14 further includes a cooling system 42 including a first cooling channel 44 arranged in first mold half 23 and a second cooling channel 46 arranged in second mold half 28. Mold 14 also includes a vacuum system 48 that creates a negative pressure in mold cavity 16 during a selected portion of the core back injection molding process as will be detailed more fully herein.

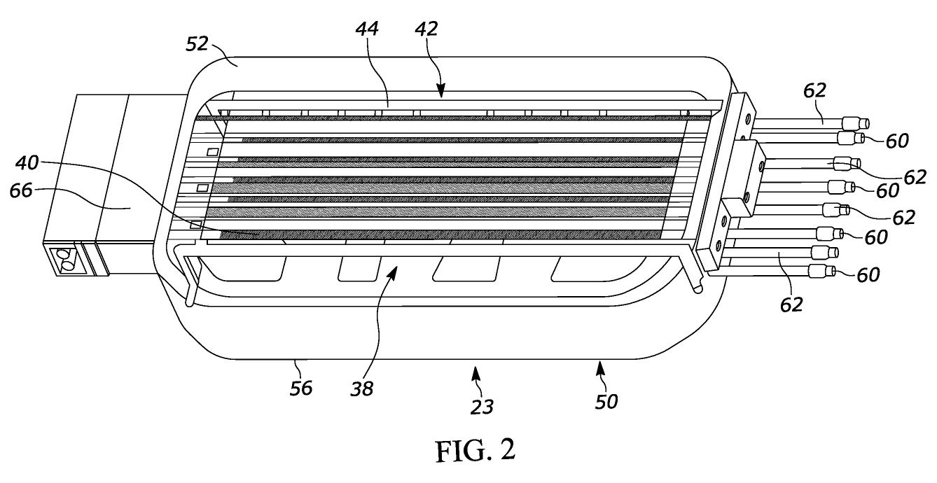

Reference will follow to FIG. 2 in describing first mold half 23 in accordance with the present disclosure. First mold half 23 includes a body 50 having and exterior surface 52 and a first molding surface 54. A parting line 56 circumscribes body 50 and defines an interface between exterior surface 52 and first molding surface 54. Parting line 56 also defines an interface between first mold half 23 and second mold half 28.

Body 50 supports a plurality of cooling system inlets 60 and a plurality of cooling system outlets 62. Cooling system inlets 60 receive a cooling fluid or coolant that is circulated through first cooling channel 44. That is, first cooling channel 44 may include multiple cooling circuits (not separately labeled) that are fed by cooling system inlets 60. Cooling system outlets 62 transport the cooling fluid to a heat exchange system (not shown) that removes heat from the cooling fluid before it is circulated back into mold 14. Body 50 also supports an induction heating connector 66 that selectively provides power to induction heating coils 40.

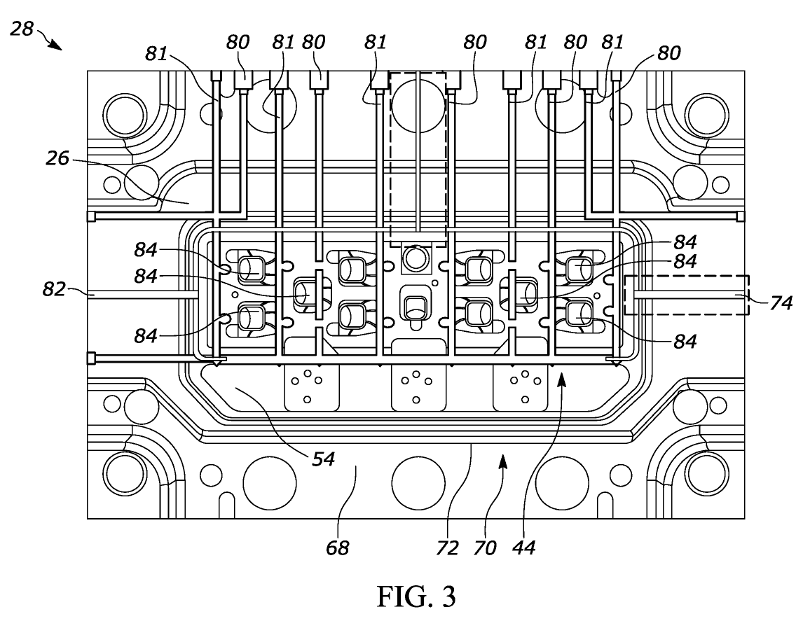

Referring to FIG. 3, second mold half 28 includes a second molding surface 68 including a groove 70 that supports a seal 72 that helps maintain the negative pressure in mold cavity 16 when vacuum system 48 is active. The negative pressure is generated through a vacuum passage 74 operatively connected to vacuum system 48. Second cooling channel 46 includes multiple cooling circuits (not separately labeled) that are fed by cooling system inlets 80. Cooling system outlets 81 transport the cooling fluid from second cooling channel 46 back to the heat exchange system.

Second mold half 28 also includes an injection port 82 that transports a molten material, infused with a foaming agent, into mold cavity 16. The molten material flows through a plurality of outlets 84. As the molten material flows, vacuum system 48 is activated during molten material injection to create the negative pressure. The negative pressure ensures that the molten material is drawn into all portions of mold cavity 16.

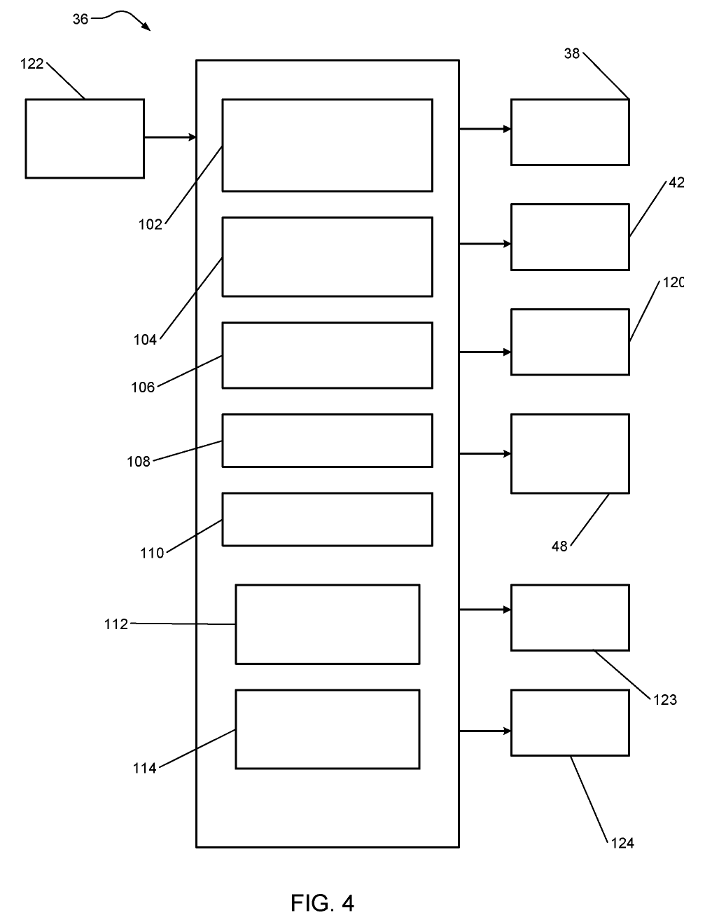

Reference will follow to FIG. 4 in describing core back controller 36 in accordance with an aspect of the present disclosure. Core back controller 36 includes a central processing unit 102, an injection control module 104, a heating control module 106, and a cooling control module 108. Core back controller 36 is also shown to include a parallelism control module 110 that maintains alignment between first mold half 23 and second mold half 28 during the core back injection molding process. Core back controller 36 is further shown to include a vacuum control module 112 and a non-transient memory module 114 that may store instructions for controlling the core back injection molding process.

In a non-limiting example, core back controller 36 is connected to induction heating system 38, cooling system 42, vacuum system 48, and a mold control system 120. Mold control system 120 controls movement of first mold half 23 as will be detailed more fully herein. Core back controller 36 is also connected to an activation input 122 that allows operators to start and/or stop the core back injection molding process as well as temperature sensors 123 that detect mold temperature and position sensors 124 that sense the relative position between first mold half 23 and second mold half 28 as will be detailed herein.

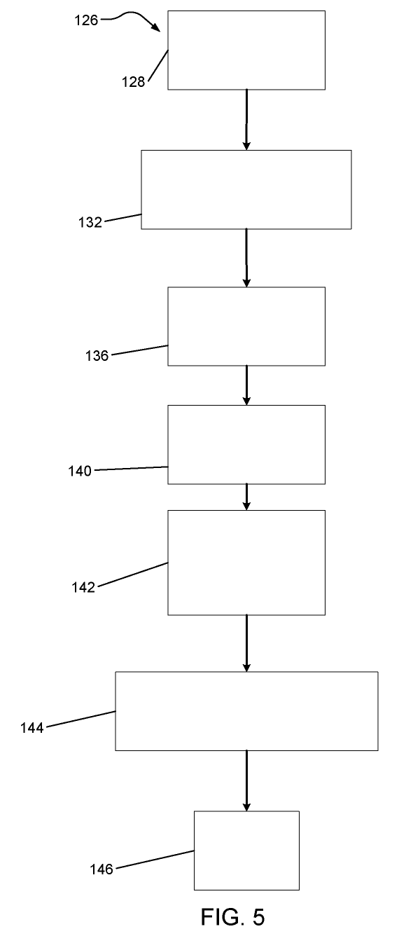

Reference will now follow to FIGS. 5, 6A, 6B, 6C, 6D, and 6E in describing the core back injection molding process 126 in accordance with an aspect of the present disclosure. In block 128, after receiving an activation command through activation input 122, mold control system 120 is activated to bring together first mold half 23 and second mold half 28 forming mold cavity 16 as shown in FIG. 6A. At this point, core back controller 36 signals cooling control module 108 to begin coolant flow. Cooling control module 108 signals cooling system 42 to pass a cooling medium through first cooling channel 44 and second cooling channel 46. Core back controller 36 also signals injection control module 104 to start injection of the molten material infused with the foaming agent in block 132 as shown in FIG. 6B.

Concurrently, core back controller 36 signals heating control module 106 to activate induction heating system 38 in block 136 to elevate temperature of body 50 to a selected heated temperature so that the molten material flows into mold cavity 16 without adhering to mold surface 54. When filling mold cavity 16, heating control module 106 monitors mold temperatures through temperature sensors 123 arranged in first mold half 23 and second mold half 28. Heating control module 106 adjusts heat output from induction heating system 38 to ensure that the molten material stays within a selected temperature range of the selected heated temperature. The selected heated temperature and the selected temperature range will vary based on the type of material being used in the core back molding process.

In block 140, vacuum control module 112 activates vacuum system 48 to create the negative pressure drawing the molten material into all corners of mold cavity 16. Alternatively, heating control module 106 may employ an open loop control algorithm that simply relies on timed on and off sequences of induction heating system 38 to establish the selected temperature.

Once the mold cavity is filled, mold control system 120 is activated, in block 142, to separate first mold half 23 and second mold half 28 a selected distance as shown in FIG. 6C. The selected distance will vary may generally be in a range of about 1 mm. Of course, the selected distance may be less than or greater than 1 mm depending on material characteristics and component design. When moving second mold half 28 to establish the selected distance, parallelism control module 110 monitors position sensors 124 to ensure that first mold half 23 and second mold half 28 remain aligned to ensure final part quality. Position sensors 124 may take on various forms including laser sensors that may measure distance between various portions of first mold half 23 and second mold half 28, accelerometers that detect forces on a mold support shaft (not shown), or other closed loop control feedback mechanisms that ensure faces (not separately labeled) of first mold half 23 and second mold half 28 remain in a selected alignment, e.g. parallel to one another when moving second mold half 28 the selected distance.

At this point, the molten begins to expand and is allowed to cool. In block 144, induction heating system 38 is deactivated and cooling control module 108 continues to flow coolant through first mold half 23 and second mold half 28 until a selected cooling temperature is reached as determined through feedback provided by temperature sensors 123 as shown in FIG. 6D. Of course, cooling control module 108 may also employ open loop techniques, such as a timed delivery of coolant, to lower mold temperatures. Once the selected cooling temperature is reached, in block 146 first mold half 23 and second mold half 28 are fully separated and the component is ejected as shown in FIG. 6E and collected in a component receiving bin (not shown).

By incorporating an induction heating system into the mold, mold temperatures are increased during material injection. By raising mold temperatures, the molten material flows more consistently over mold surfaces during injection, fill, and expansion. The more consistent flow ensures that the molten material flows into surface details, such as simulated wood grains, decorative details and the like on mold cavity surfaces that are left on the final component. The more consistent flow also reduces any surface imperfections that may occur if the molten material adheres to mold surfaces during injection, fill, and expansion.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A core back injection molding system comprising:
a mold including a mold body having a mold cavity, the mold body including a first mold half having a first portion of the mold cavity and a second mold half having a second portion of the mold cavity;
an induction heating system including an induction heating coil in the first mold half; and
a core back controller operatively connected to the mold, and the induction heating system, the core back controller being configured to:
fill the mold cavity with a molten material including a foaming agent;
separate the first mold half from the second mold half a selected amount allowing the foaming agent to expand the molten material;
activate the induction heating system to promote flow of the molten material in the mold cavity; and
eject a part formed from the molten material from the mold.

2. The core back injection molding system according to claim 1, further comprising a cooling system including a first cooling channel extending through the first mold half and a second cooling channel extending through the second mold half.

3. The core back injection molding system according to claim 2, wherein the core back controller is configured to deactivate the induction heating system allowing the molten material to cool and solidify.

4. The core back injection molding system according to claim 1, wherein one of the first mold half and the second mold half includes a seal that extends about the corresponding one of the first portion of the mold cavity and the second portion of the mold cavity.

5. The core back injection molding system according to claim 4, further comprising a vacuum system fluidically connected to the mold cavity, wherein the core back controller is configured to activate the vacuum system to draw the molten material into the mold cavity.

6. The core back injection molding system according to claim 1, wherein the core back controller includes a parallelism module configured to maintain alignment of the first mold half and the second mold half.

7. A core back controller comprising:
an injection module;
a core back module;
an induction heating control module, wherein the core back controller is configured to:
activate the injection module to inject a molten material including a foaming agent into a mold having a mold cavity , the mold cavity having a first portion defined in a first mold half and a second portion defined in a second mold half;
separate the first mold half from the second mold half a selected amount allowing the foaming agent to expand the molten material through the core back module;
control an induction heating system through the induction heating control module to promote flow of the molten material in the mold cavity; and
fully separate the first mold half and the second mold half to eject a part formed from the molten material from the mold.

8. The core back controller according to claim 7, wherein the core back controller is configured to activate a cooling system to pass a turbulent flow of coolant through the mold reduce mold temperatures after deactivating the induction heating system.

9. The core back controller according to claim 8, wherein the core back controller is configured to pass coolant through a first cooling channel arranged in the first mold half and a second cooling channel arranged in the second mold half.

10. The core back controller according to claim 7, wherein the core back controller is configured to close the mold creating a seal between the first mold half and the second mold half.

11. The core back controller according to claim 10, wherein the core back controller is configured to activate a vacuum system creating a negative pressure in the mold cavity when injecting the molten material.

12. The core back controller according to claim 7, wherein the core back controller includes a parallelism module configures to maintain alignment between the first mold half and the second mold half.

13. A method of forming a component with a core back injection molding process, the method comprising:
filling a mold cavity defined between a first mold half and a second mold half of a mold with molten material including a foaming agent;
activating an induction heating system embedded in one of the first mold half and the second mold half to heat the mold and the molten material;
separating the mold by shifting the first mold half away from the second mold half a selected distance allowing the molten material to expand and solidify to form a component; and
ejecting the component from the mold.

14. The method of claim 13, further comprising activating a cooling system to pass a turbulent flow of coolant through the mold to cool the molten material.

15. The method of claim 14, wherein activating the cooling system includes passing a cooling medium through a cooling channel arranged in at least one of the first mold half and the second mold half when filling the mold cavity.

16. The method of claim 15, wherein passing the cooling medium through the cooling channel includes maintaining the turbulent flow of cooling medium through a first cooling channel arranged in the first mold half and a second cooling channel arranged in the second mold half after deactivating the induction heating system.

17. The method of claim 13, further comprising engaging a seal arranged about a first portion of the mold cavity formed in the first mold half with the second mold half to form the mold cavity.

18. The method of claim 17, further comprising creating a negative pressure in the mold cavity when filling with the molten material.

19. The method of claim 13, further comprising maintaining alignment between the first mold half and the second mold half when separating the mold.

20. The method of claim 13, wherein activating an induction heating system includes activating an induction heating coil arranged in the first mold half.
